(19) United States
(12) Patent Application Publication
(10) Pub. No.: US 2004/0091143 A1
(43) Pub. Date: May 13, 2004

(54) Two and three dimensional skeletonization

(76) Inventor: Qingmao Hu, Singapore (SG)

Correspondence Address: SUGHRUE MION, PLLC, 2100 PENNSYLVANIA AVENUE, N.W., SUITE 800, WASHINGTON, DC, 20037, US

(21) Appl. No.: 10/466,830

(22) PCT Filed: Jan. 22, 2001
(86) PCT No.: PCT/SG01/00008

(51) Int. Cl. G06K 9/00; G06K 9/42; G06K 9/44

(52) U.S. Cl. 382/154; 382/128; 382/259

(57) ABSTRACT

A method is disclosed for determining skeletons of any two dimensional images and three-dimensional skeletons of vessel trees. In the three dimensional case, the method takes a binary volume of any vessel tree as input and produces centred, connected and one-voxel wide skeleton of the input vessel tree. In the two dimensional case, centred, connected and one-pixel wide skeletons of input binary images are produced. The method includes the steps of: (1) calculating a 3D/2D distance transform, (2) locating local maximum voxels/pixels, one-voxels/pixel, (3) propagating skeletal elements to get a full set of skeletal elements, and (4) removing redundant local maximum voxels/pixels to obtain a one-voxel/pixel wide skeleton.

### FIELD OF THE INVENTION

This invention relates to a method of and system for calculating the skeleton of three dimensional binary volume images and two dimensional binary images. More specifically, this invention relates to a method of and system for producing three-dimensional skeletons for vessel trees such as human vessel trees, and a method of and system for producing two-dimensional skeletons for any two-dimensional binary images.

### BACKGROUND

Skeletonization denotes the process where objects are reduced to structures of lower dimension. In other words, skeletonization reduces two-dimensional images to planar curves, and three-dimensional volumetric images to a set of three-dimensional surfaces or curves.

Two-dimensional skeletonization is a process commonly used in computer vision and pattern recognition and there are continual efforts to improve the quality and to increase the speed of skeletonization.

There are some patents on two dimensional skeletonization, such as U.S. Pat. No. 5,224,179 entitled “Image skeletonization method”. This disclosure is based upon templates and could have “hairy” branches. Similarly, skeletons produced using the methods described in U.S. Pat. No. 5,023,920 and the paper entitled “Generating skeletons and centerlines from the distance transform” CVGIP: Graphical Models and Image Processing, vol. 54, no. 5, by C. W. Niblack, P. B. Gibbons, D. W. Capson also display such undesirable traits. The problem of hairy skeleton branches was recognised in the Niblack et al paper, but a solution was not offered.

There is therefore a need for a two-dimensional skeletonization method of improved quality so as to produce a neater skeleton.

The skeletonization of three-dimensional volume images also has many applications, particularly in the fields of image processing, pattern recognition and computer graphics, and more specifically in relation to medical image analysis such as in cardiology, neurology and radiology areas. Some two-dimensional skeletonization methods have been adapted for three dimensional images, but with limited success, as the extension of this knowledge to three-dimensional volumetric images is non-trivial.

One attempt to extend the achievement in two-dimensional skeletonization to three-dimensions is described in a publication entitled “Skeletonization applied to magnetic resonance angiography images,” SPIE Conference on Image Processing (1998, SPIE Vol. 3338): 693-701 by I. Nystroem. The skeleton resulting from this approach however is not as good as that achieved for two-dimensional cases, since there are many undesirable protrusions.

Another skeletonization method aiming at three-dimensional data was put forward in a publication entitled “Efficient skeletonization of volumetric objects,” IEEE Transactions on Visualization and Computer Graphics, vol. 5, no. 3, pp.196-209, by Y. Zhou and A. Toga. The resultant skeleton, however, was not able to guarantee centeredness.

There are also some patents on skeletonization and extraction of vessel skeletons. U.S. Pat. No. 5,699,799 entitled “Automatic Determination of the Curved Axis of a 3D Tube-shaped Object in Image Volume” is for one vessel only, however and is not applicable to vessel trees. U.S. Pat. No. 5,224,179 entitled “Image Skeletonization Method” is for skeletonization of two-dimensional binary images and cannot be extended to three-dimensional. Similarly, U.S. Pat. No. 5,023,920 entitled “Method for Finding the Medial Axis Transform of an Image” is a 2D method to get the medial axis of a 2D binary image, and cannot be extended to 3D.

U.S. Pat. No. 6,047,080 entitled “Method and Apparatus for Three-Dimensional Reconstruction of Coronary Vessels from Angiographic Images” is essentially a method to reconstruct a three-dimensional structure by stereo principle. This approach is inherently a two-dimensional skeletonization method, and as such has an inherent correspondence problem in both building up the correspondence and locating the correspondence. Further, the 3D centerline is calculated from the correspondence of the 2D centerline.

There is therefore also a need for a more efficient three-dimensional skeletonization method.

Accordingly, it is an object of the present invention to overcome or ameliorate at least one of the problems of the prior art.

In this regard it is desirable to provide an improved 3D skeletonization and associated apparatus.

It is also desirable to provide an improved 2D skeletonization and associated apparatus.

### SUMMARY OF THE INVENTION

According to one aspect, the present invention provides a method of skeletonizing a three dimensional binary volume image including the steps of locating any local maximum voxels in the volume image; locating any one-voxel wide valley voxels in the volume image; locating any two-voxel wide valley voxels in the volume image; and forming a current primary skeleton, wherein the initial skeletal elements comprise the located local maximum voxels, one-voxel wide valley voxels and two-voxel wide valley voxels.

According to another aspect, the present invention provides a method of skeletonizing a two dimensional binary image including the steps of: locating any local maximum pixels in the binary image; locating any one-pixel wide valley pixels in the binary image; locating any two-pixel wide valley pixels in the binary image; and forming a current primary skeleton, wherein the initial skeletal elements comprise the local maximum pixels, one-pixel wide valley pixels and two-pixel wide valley pixels.

According to a further aspect, the present invention provides a computer program product including a computer usable medium having computer readable program code and computer readable system code embodied on said medium for skeletonizing both three-dimensional and two-dimensional binary images within a data processing system, said computer program product further including computer readable code within said computer usable medium for: locating any local maximum voxels/pixels in the three-dimensional/two-dimensional image; locating any one-voxel/pixel wide valley voxels/pixels in the three-dimensional/two-dimensional image; locating any two-voxel/pixel wide valley voxels/pixels in the three-dimensional/two-dimensional image; and forming a current primary skeleton, wherein the initial skeletal elements comprise the located local maximum voxels/pixels, one-voxel/pixel wide valley voxels/pixels and two-voxel/pixel wide valley voxels/pixels.

The disadvantages of prior methods for extracting the skeleton of vessel trees are overcome with the present invention in that it provides an improved method for extracting the 3D skeleton of binary images, such as of human vessel trees. Similarly, the disadvantages of prior methods for extracting the skeleton of any two-dimensional binary images are overcome in that this invention yields neater skeletons.

The present invention is made possible using the novel concepts of, in the three dimensional case, one-voxel wide valley voxels and two-voxel wide valley voxels, and in the two dimensional case, one-pixel wide valley pixels and two-pixel wide valley pixels. Together with the local maximum voxels/pixels these one-voxel/pixel wide valley voxels/pixels and two-voxel/pixel wide valley voxels/pixels are used to form the backbone of the current primary skeleton.

According to a preferred embodiment of the invention, a propagation process is also performed, which allows the 3D skeleton of vessel trees and 2D skeleton of any shaped two-dimensional objects to be achieved efficiently.

Further, according to another preferred embodiment of the invention, distance transforms are performed on the image, which are based upon local Euclidean metric and a look up table of discrete distance values. In this embodiment, the combination of a lookup table and the local Euclidean metric ensures the accurateness of the distance transform, which in turn helps to achieve centeredness of the skeleton.

### BRIEF DESCRIPTION OF THE DRAWINGS

The invention may best be understood by reference to the following description in conjunction with the accompanying drawings, in which:

FIG. 1 is a flow chart illustrating the steps for calculating the skeleton of three dimensional vessel trees according to an embodiment of the present invention.

FIG. 2 is a flow chart illustrating the steps for performing three-dimensional distance transforms according to an embodiment of the present invention.

FIG. 3 is an example of a one-voxel wide valley voxel in two-dimensional case, with shown values being the distance indexes and the center voxel being a one-voxel wide voxel.

FIG. 4 is a flow chart indicating the steps to locate one-voxel wide valley voxels according to an embodiment of the present invention.

FIG. 5 is an example of a two-voxel wide valley in two-dimensional case, with the voxels marked * being the two-voxel wide valley.

FIG. 6 is a flow chart indicating the steps to locate two-voxel wide valley voxels according to an embodiment of the present invention.

FIG. 7 is a flow chart illustrating the steps to propagate an initial primary skeleton to get the final primary skeleton according to an embodiment of the invention.

FIG. 8 is a flow chart illustrating the steps to propagate a skeletal element candidate to locate new skeletal elements according to an embodiment of the invention.

FIG. 9 is a diagram of a two-dimensional array where the surface patch of 5 is marked with *.

FIG. 10 is a flow chart illustrating the removal of redundant local maximum voxels according to an embodiment of the invention.

FIG. 11 is a flow chart illustrating the steps for calculating the skeleton of any two dimensional binary images according to an embodiment of the present invention.

FIG. 12 is a flow chart illustrating the steps for performing two-dimensional distance transforms according to an embodiment of the present invention.

FIG. 13 is a flow chart indicating the steps to locate one-pixel wide valley pixels according to an embodiment of the present invention.

FIG. 14 is a flow chart indicating the steps to locate two-pixel wide valley pixels according to an embodiment of the present invention.

FIG. 15 is a flow chart illustrating the removal of redundant local maximum pixels according to an embodiment of the invention.

FIG. 16 is an illustration of a real human vessel tree.

FIG. 17 is an illustration of the real human vessel tree shown in FIG. 11 overlaid with a skeleton calculated using a method according to the present invention.

FIG. 18 is an illustration of a two dimensional binary image with a skeleton calculated using the present invention overlaid.

FIG. 19 is an illustration of a two dimensional binary image with a skeleton calculated using Hilditch's method.

### DETAILED DESCRIPTION

Two Dimensional Images

In the two dimensional image processing domain, a pixel is the smallest unit square in the image to be processed. A binary image is an image where each pixel will take either one or zero. All pixels taking one are called foreground pixels or object pixels and pixels taking zero are called background pixels.

In a two dimensional image, a Cartesian coordinate system can be built up, with the two axes being denoted as X and Y and having the same scale. The coordinates of any pixel are denoted as (x, y) and x and y are supposed to be non-negative integers and to be within some range.

The Euclidean distance between any two pixels P₀(x₀, y₀) and P₁(x₁, y₁) is calculated by

|P₀P₁|=sqrt((x₀−x₁)²+(y₀−y₁)²)

where sqrt stands for square root.

When |P₀P₁| is 1, pixels P₀ and P₁ are called 4-connected or 4 adjacent, and they are 4 neighbor to each other. Likewise, when |P₀P₁| is either 1 or 1.414, then P₀ and P₁ are called 8-connected or 8 adjacent, and they are 8 neighbor to each other.

Two pixels are adjacent or neighbors to each other if they are at least 8-connected. A pixel path is defined as a sequence of pixels satisfying the condition that adjacent pixels are at least 8-connected and every other pair of pixels is disconnected. A set of pixels is connected if, for any pixels within it, there is a path within the set connecting them; otherwise it is disconnected.

By skeleton of a two dimensional binary image it means a subset of pixels S of the binary image that satisfy the following criteria:

(1) they have the same connectivity as the original binary image;

(2) they allow the binary image to be reconstructed to within a specified, known error along its border, where the reconstruction is done using only the S and the values from the corresponding distance transform along S, and

(3) they should be thin, more specifically, except at bifurcation positions, the path in S should be unique.

Three Dimensional Image Volumes

Likewise, in the three dimensional image processing domain, a voxel is the smallest unit cube in the image volume to be processed. A binary volume is an image volume where each voxel will take either one or zero. All voxels taking one are called foreground voxels or object voxels, and voxels taking zero are called background voxels.

In an image volume, a Cartesian coordinate system can be built up, with three axes being denoted as X, Y, and Z respectively. The position of each voxel in the image volume is represented by its coordinates (x, y, z), where x, y, and z are all non-negative integers. Furthermore, x, y, and z are supposed to be within certain range, i.e.,

0<=x<Lₓ

0<=y<L_{y}

0<=z<L_{z}

where Lₓ, L_{y}, and L_{z}are some constants, and they all normally take the value of 128, 256, or 512.

It is also supposed that the three axes of image volumes have the same scale.

The Euclidean distance between any two voxels P₀(x₀, y₀, z₀) and P₁(x₁, y₁, z₁) is calculated by

|P₀P₁|=sqrt((x₀−x₁)²+(y₀−y₁)²+(z₀−z₁)²)

where sqrt stands for square root.

When |P₀P₁| is 1, voxels P₀ and P₁ are called 6-connected or 6 adjacent, and they are 6 neighbor to each other. Likewise, when |P₀P₁| is either 1 or 1.414, then P₀ and P₁ are called 18-connected or 18 adjacent, and they are 18 neighbor to each other; when |P₀P₁| is either 1 or 1.414 or 1.732, then P₀ and P₁ are 26-connected or 26 adjacent, and they are 26 neighbor to each other.

Two voxels are adjacent or neighbors to each other if they are at least 26-connected. A voxel path is defined as a sequence of voxels satisfying the condition that adjacent voxels are at least 26-connected and every other pair of voxels is disconnected. A set of voxels is connected if, for any voxels within it, there is a path within the set connecting them; otherwise it is disconnected.

By skeleton of a vessel tree it means a subset voxels S of the vessel tree that satisfy the following criteria:

(4) they have the same connectivity as the original vessel tree;

(5) they allow the vessel tree to be reconstructed to within a specified, known error along its border, where the reconstruction is done using only the S and the values from the corresponding distance transform along S, and

(6) they should be thin, more specifically, except at bifurcation positions, the path in S should be unique.

Three Dimensional Skeletonization

A first embodiment of the present invention will now be described in relation to producing a one voxel wide skeleton of a binary volume of a vessel tree.

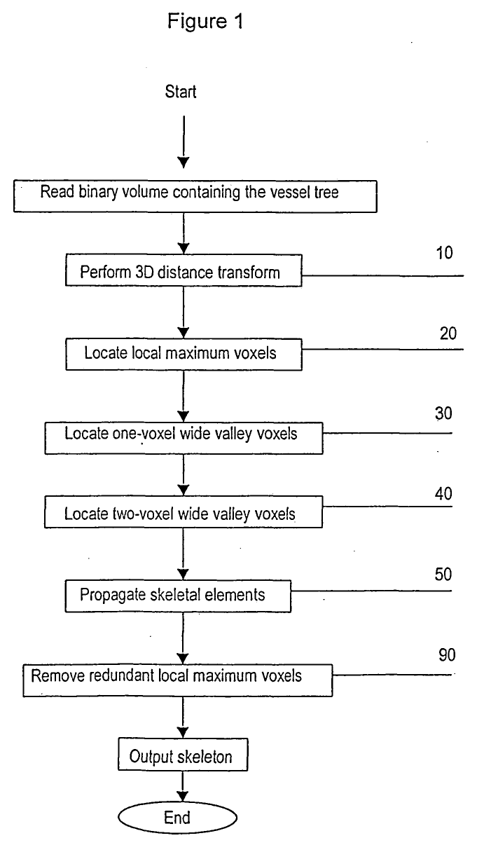

Referring now to FIG. 1, a method according to this embodiment of the present invention includes the following six major steps:

1. performing 3D distance transform (10);

2. locating local maximum voxels (20);

3. locating one-voxel wide valley voxels (30);

4. locating two-voxel wide valley voxels (40);

5. propagating skeletal elements (50); and

6. removing redundant local maximum voxels (90).

The above-described steps will be described in greater detail herewith.

For the purposes of this discussion, a binary volume image containing the vessel trees will be defined to be a three dimensional array of voxels, denoted as IM (x, y, z). The x, y, and z indexes represent the X coordinate, Y coordinate, and Z coordinate of a voxel respectively. IM (x, y, z) takes the value of either 1 or 0, with 1 for the voxels on vessel trees (object voxels), and 0 for background voxels.

A 6-boundary voxel is an object voxel that has at least one of its 6-connected neighbors being a background voxel. Likewise, an 18-boundary voxel is an object voxel that has at least one of its 18-neighbors being a background voxel; a 26-boundary voxel is an object voxel that has at least one of its 26-neighbors being a background voxel. All the 6-boundary voxels, 18-boundary voxels, and 26-boundary voxels are called boundary voxels.

An interior voxel is an object voxel with all its 26-connected neighbors being object voxels. A voxel p's. 26 neighbors are denoted as Nₚ.

A data item is an ordered set of quantities. For example, the three-dimensional coordinates of a voxel together with its distance index is a kind of data item (see below for the concept of distance index). A queue is a first in first out (FIFO) data structure for any data items. A list is a data structure where data items can be inserted from either the head or the tail of the list, while retrieval can also be done from both sides.

Performing Three-dimensional Distance Transform

A three-dimensional distance transform is a process to iteratively assign a distance value to all the object voxels. The distance transform in the present embodiment of the invention is based on the differentiation of 3 kinds of different boundary voxels and a lookup table. Instead of setting all the boundary voxels' distance values to 0, the distance value of any object voxels with only 26-connected neighbor background voxels is defined as 0.866, the distance value of any object voxels with only 18-connected neighbor background voxels is defined as 0.717, and the distance value of any object voxels with only 6-connected neighbor background voxels is defined as 0. These three kinds of boundary voxels are denoted as 26-boundary voxels, 18-boundary voxels, and 6-boundary voxels respectively.

With the distance values 0, 0.717, 0.866 for boundary voxels and the local Euclidean metric (1, 1.414, 1.732) for iteration, a lookup table can be built for all the possible discrete distance values an object voxel could take, in an increasing order. This lookup table builds a unique correspondence between the three-dimensional distance transform value and its index. The index corresponding to the specific distance value is called the distance index hereafter.

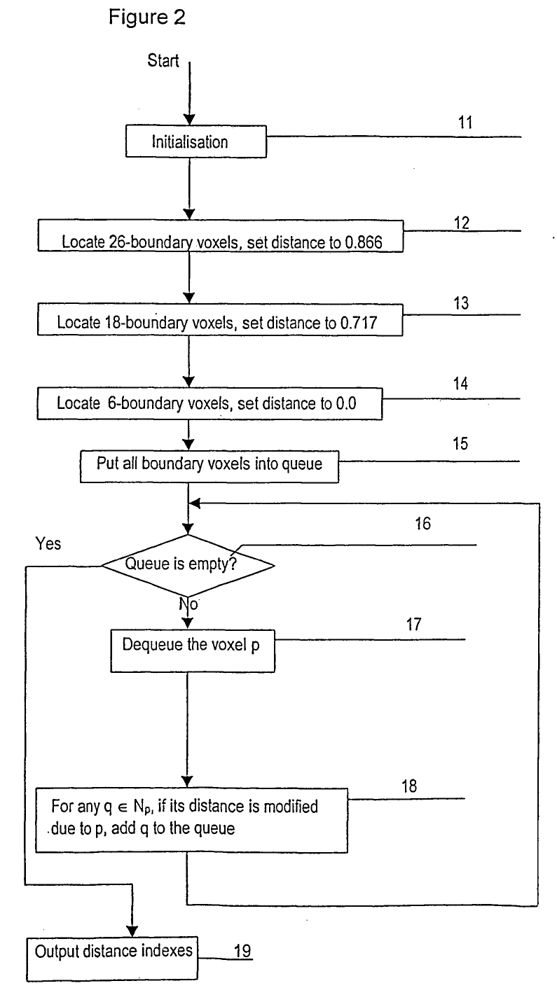

Now referring to FIG. 2, the three-dimensional distance transform according to an embodiment of the invention is illustrated.

The first step is initialization (11). This includes finding all the object voxels and setting their distance values to infinitive. In this invention, the infinitive value is set to 5000. For all the background voxels, their distance values are set to any negative integer like −10.

Then the 26-boundary, 18-boundary, and 6-boundary voxels are located and their distance values are set to 0.866, 0.717, and 0 respectively (12, 13, 14). All these boundary voxels coordinates together with their distance values are put into a queue (15). The queue is then checked (16).

If the queue is not empty, a voxel p with its distance value d(p) is dequeued (17) and its 26 neighbors Nₚchecked.

For any object voxel qεNₚ, suppose its current distance value is d(q). Then d(q) is compared with d(p)+δ(p), where δ(p) will take the value of 1, 1.414, or 1.732 if q is a 26-, 18-, or 6-connected neighbor of p. If d(p)+δ(p) is smaller than d (q), then d(q) is set to be d(p)+δ(p), and q is put into the queue (18). Steps (17) to (18) are then reiterated until the queue is empty.

If the queue is empty, the calculated distance values of all the object voxels are checked against a lookup table as shown in table 1 (see below) to get the distance indexes of all the object voxels (19).

In the subsequent processing, it is the distance indexes rather than the distance values that will be used. For example, from Table 1, the 41 st entry of the distance value is 4.41. Thus a distance of 4.41 will have a distance index of 41 associated with it. Table 1 shows the lookup table for distance not greater than 10. For larger distance values, the corresponding distance indexes can also be found.

TABLE 1
Lookup Table for Three-Dimensional Distance Transform of Distance
Values not Greater than 10

| | | | | | | | | | |
|---|---|---|---|---|---|---|---|---|---|
| 0.00 | 0.71 | 0.87 | 1.00 | 1.41 | 1.71 | 1.73 | 1.87 | 2.00 | 2.12 |
| 2.28 | 2.41 | 2.44 | 2.60 | 2.71 | 2.73 | 2.82 | 2.87 | 3.00 | 3.12 |
| 3.14 | 3.28 | 3.41 | 3.44 | 3.46 | 3.53 | 3.60 | 3.69 | 3.71 | 3.73 |
| 3.82 | 3.85 | 3.87 | 4.00 | 4.01 | 4.12 | 4.14 | 4.17 | 4.23 | 4.28 |
| 4.33 | 4.41 | 4.44 | 4.46 | 4.53 | 4.55 | 4.60 | 4.69 | 4.71 | 4.73 |
| 4.82 | 4.85 | 4.87 | 4.94 | 5.00 | 5.01 | 5.10 | 5.12 | 5.14 | 5.17 |
| 5.19 | 5.23 | 5.26 | 5.28 | 5.33 | 5.41 | 5.42 | 5.44 | 5.46 | 5.53 |
| 5.55 | 5.58 | 5.60 | 5.64 | 5.69 | 5.71 | 5.73 | 5.74 | 5.82 | 5.85 |
| 5.87 | 5.90 | 5.94 | 5.96 | 6.00 | 6.01 | 6.06 | 6.10 | 6.12 | 6.14 |
| 6.17 | 6.19 | 6.23 | 6.26 | 6.28 | 6.33 | 6.35 | 6.41 | 6.42 | 6.44 |
| 6.46 | 6.51 | 6.53 | 6.55 | 6.58 | 6.60 | 6.64 | 6.67 | 6.69 | 6.71 |
| 6.73 | 6.74 | 6.82 | 6.83 | 6.85 | 6.87 | 6.90 | 6.92 | 6.94 | 6.96 |
| 6.99 | 7.00 | 7.01 | 7.05 | 7.06 | 7.10 | 7.12 | 7.14 | 7.15 | 7.17 |
| 7.19 | 7.23 | 7.26 | 7.28 | 7.31 | 7.33 | 7.35 | 7.37 | 7.41 | 7.42 |
| 7.44 | 7.46 | 7.47 | 7.51 | 7.53 | 7.55 | 7.58 | 7.60 | 7.63 | 7.64 |
| 7.67 | 7.69 | 7.71 | 7.73 | 7.74 | 7.76 | 7.79 | 7.82 | 7.83 | 7.85 |
| 7.87 | 7.90 | 7.92 | 7.94 | 7.96 | 7.99 | 8.00 | 8.01 | 8.05 | 8.06 |
| 8.08 | 8.10 | 8.12 | 8.14 | 8.15 | 8.17 | 8.19 | 8.23 | 8.24 | 8.26 |
| 8.28 | 8.31 | 8.33 | 8.35 | 8.37 | 8.40 | 8.41 | 8.42 | 8.44 | 8.46 |
| 8.47 | 8.51 | 8.53 | 8.55 | 8.56 | 8.58 | 8.60 | 8.63 | 8.64 | 8.65 |
| 8.67 | 8.69 | 8.71 | 8.72 | 8.73 | 8.74 | 8.76 | 8.78 | 8.79 | 8.82 |
| 8.83 | 8.85 | 8.87 | 8.88 | 8.90 | 8.92 | 8.94 | 8.96 | 8.99 | 900 |
| 9.01 | 9.04 | 9.05 | 9.06 | 9.08 | 9.10 | 9.12 | 9.14 | 9.15 | 9.17 |
| 9.19 | 9.20 | 9.23, | 9.24 | 9.26 | 9.28 | 9.31 | 9.33 | 9.35 | 9.36 |
| 9.37 | 9.40 | 9.41 | 9.42 | 9.44 | 9.46 | 9.47 | 9.49 | 9.51 | 9.52 |
| 9.53 | 9.55 | 9.56 | 9.58 | 9.60 | 9.63 | 9.64 | 9.65 | 9.67 | 9.69 |
| 9.71 | 9.72 | 9.73 | 9.74 | 9.76 | 9.78 | 9.79 | 9.81 | 9.82 | 9.83 |
| 9.85 | 9.87 | 9.88 | 9.90 | 9.92 | 9.94 | 9.96 | 9.97 | 9.99 | |

Locating Local Maximum Voxels

A local maximum voxel is an object voxel whose distance is not smaller than that of any of its 26-connected neighbors. This concept is described in a publication entitled “generating skeletons and centerlines from the distance transform,” CVGIP: Graphical Models and Image Processing, vol. 54, no. 5, pp 420-437, 1992 by C. W. Niblack, P. B. Gibbons, and D. W. Capson. Obviously, a non-local maximum voxel is an object voxel that is not a local maximum voxel.

In the present invention however, the distance index is preferably used to locate such voxels. Nevertheless, the set of all the local maximum voxels should be the same since from the lookup table, the same distance will have the same distance index, and a larger distance will have a larger distance index. The lookup table has been devised to allow floating number arithmetic to be implemented in the integer domain.

The local maximum voxels are located by identifying the local maxima from the distance indexes of the three-dimensional distance transform. These local maxima are the local maximum voxels.

Locating One-Voxel Wide Valley Voxels

For any binary volume V defined on a cuboid lattice, a component is a set of voxels satisfying the following two conditions:

1. All the voxels in the component are object voxels;

2. For any voxel in the component, there is a path from this voxel to any other voxel of the component so that all the voxels on the path belong to the component.

The “number of objects” of a binary volume V is defined as the number of components within V.

For any object voxel p in IM(x, y, z), its distance index is denoted as Id(p), its X coordinate is denoted as p(x), Y coordinate p(y), and Z coordinate p(z) respectively.

A 3×3×3 binary volume related to voxel p, denoted as V_{ind3}^{(p)}(x y, z) is formed in the following way:

1. V_{ind3}^{(p)}(1, 1, 1)=0;

2. For any voxel q, qεNₚ, if its distance index Id(q) is bigger than that of p, then the corresponding element in V_{ind3} (x, y, z) is set to 1, else set to 0.

That is to say,

V_{ind3}^{(p)}(q(x)−p(x)+1, q(y)−p(y)+1, q(z)−p(z)+1)

will be set to 1 if Id(q)>Id(p), or 0 if Id(q)<=Id(p).

V_{ind3}^{(p)}(x, y, z) (0<=x<3, 0<=y<3, 0<=z<3) is called the induced volume of voxel p.

A voxel p is called a one-voxel wide valley voxel if the number of objects of its induced volume is at least 2.

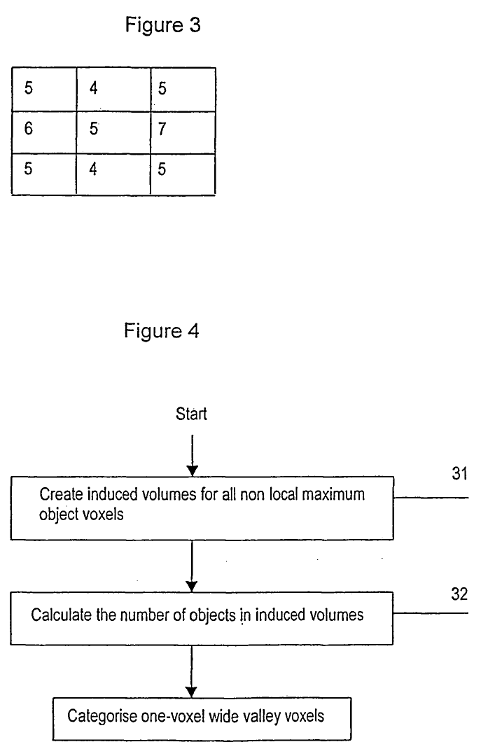

FIG. 3 shows an example of a one-voxel wide valley voxel in a two-dimensional case. Since the values are distance indexes of a 3 by 3 rectangular region, it is clear that the number of objects of the centre voxel is 2. Thus the centre voxel is a one-voxel wide valley voxel.

In FIG. 4, a flow chart for locating one-voxel wide valley voxels is illustrated. Firstly, for all the non-local maximum object voxels, induced volumes are created (31). Then the number of objects for each induced volume is calculated (32). If this number is at least 2, then the corresponding voxel is a one-voxel wide valley voxel.

The concept of one-voxel wide valley voxels is unique to the present embodiment of the invention.

Locating Two-Voxel Wide Valley Voxels

Two object voxels are called a pair of equal-distance voxels if they have the same distance index and are at least 26-neighbors.

Suppose that two object voxels p₁ and p₂ are a pair of equal-distance voxels with distance index Id (p₁).

A 5×5×5 binary volume related to p₁ and p₂, denoted as V_{ind5}^{(p1, p2)}(x, y, z), is formed in the following way:

1. V_{ind5}^{(p1, p2)}(x, y, z) is initialized to 0 for 0<=x<5, 0<=y<5, 0<=z<5;

2. For any object voxel q, qεNₚ₁ or qεNₚ₂, if its distance index Id (q) is bigger than Id (p₁), then the corresponding element in V_{ind5}^{(p1, p2)}(x, y, z) is set to 1. That is to say,

V_{ind5}^{(p1, p2)}(q(x)−p₁(x)+2, q(y)−p₁(y)+2, q(z)−p₁(z)+2)

and

V_{ind5}^{(p1, p2)}(q(x)−p₂(x)+2, q(y)−p₂(y)+2, q(z)−p₂(z)+2)

will be set to 1 if Id (q)>Id (p₁).

V_{ind5}^{(p1, p2)}(x, y, z) (0<=x<5, 0<=y<5, 0<=z<5) is called the induced volume of an equal-distance pair of voxels p₁ and p₂, hereinafter called the induced pair volume for short.

Two object voxels are two-voxel wide valley voxels, if they satisfy the following conditions:

1. They are a pair of equal-distance voxels;

2. In their 26 neighbors, there is no one-voxel wide valley voxel;

3. In their 26 neighbors, there are no two-voxel wide valley voxels;

4. The number of objects of the induced pair volume of the equal-distance pair is at least 2.

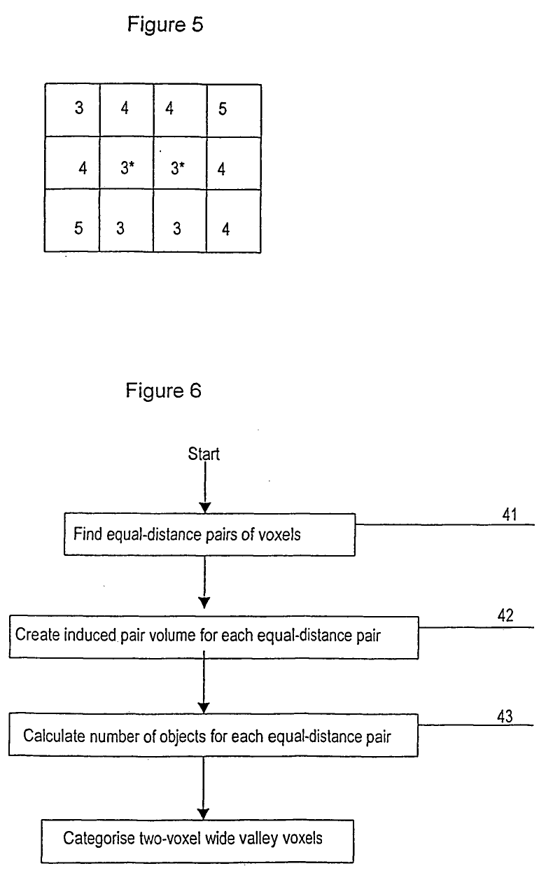

FIG. 5 shows an example of a two-voxel wide valley in the two-dimensional case. The two-voxel wide valley voxels are marked with * and the distance indexes are shown.

Now referring to FIG. 6, a flow chart for locating two-voxel wide valley voxels is illustrated. For all the non-local maximum object voxels, find all the possible equal-distance pairs of voxels (41). Create the induced pair volumes for all the equal-distance pairs that have no neighboring voxels being either one-voxel wide valley or two-voxel wide valley voxels (42). Calculate the number of objects for each induced pair volume (43), and if this number is at least 2, then the corresponding voxel pair is a two-Voxel wide valley.

The concept of two-voxel wide valley voxels is also unique to the present embodiment of this invention.

Propagating Skeletal Elements

An object voxel is a skeletal element if it satisfies one of the following conditions:

1. It is a local maximum voxel;

2. It is a one-voxel wide voxel;

3. It is a part of a two-voxel wide valley voxels;

4. The number of objects in its s-induced volume (see below for definition) is at least 2;

The s-induced volume of an object voxel p, denoted as Vₛ^{(p)} (x, y, z), is a 3×3×3 binary volume formed in the following way:

1. Initialize Vₛ^{(p)}(x, y, z) to 0 for 0<=x<3, 0<=y<3, and 0<=z<3;

2. For any object voxel q, qεNₚ, if q's distance index is bigger than that of p, or q is already a skeletal element, then the corresponding element in Vₛ^{(p)} (x, y, z) is set to 1.

That is to say,

Vₛ^{(p)}(q(x)−p(x)+1, q(y)−p(y)+1, q(z)−p(z)+1)

will be set to 1 if

Id(q)>Id(p), or

voxel q is already a skeletal element.

The union of all the skeletal elements is called the primary skeleton or the final primary skeleton. At a stage where just some of the skeletal elements are available, then the union of the currently available skeletal elements is called the current primary skeleton. The current primary skeleton is a subset of the primary skeleton. The purpose of skeletal element propagation is to find the final primary skeleton.

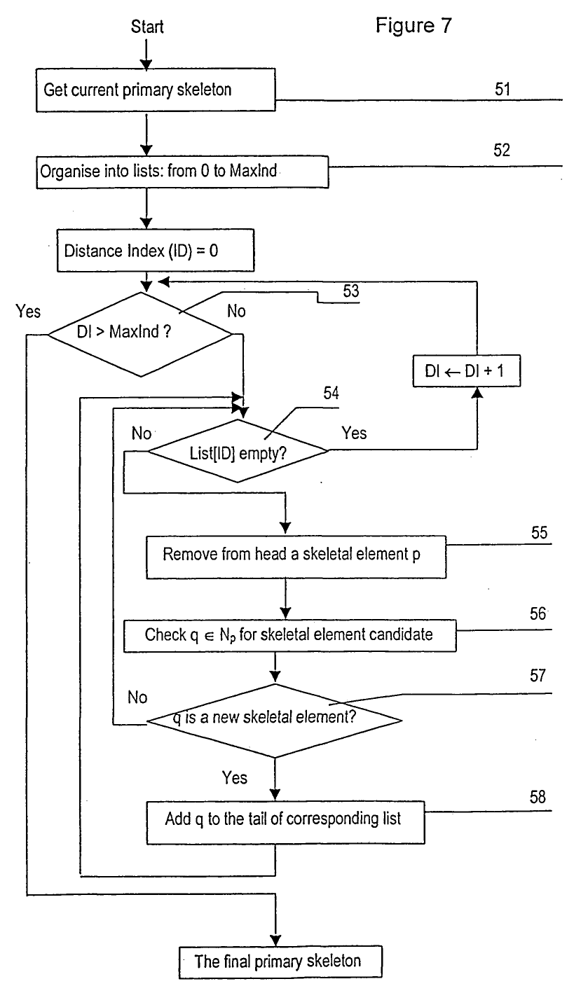

Now referring to FIG. 7 a flow chart of the propagation from an initial primary skeleton to the final primary skeleton is shown.

The initial current primary skeleton is formed from the local maximum voxels, one-voxel wide valley voxels, and two-voxel wide valley voxels (51). The maximum of the distance indexes is MaxInd, and the current primary skeleton is organized into MaxInd number of lists, with each list containing the current skeletal elements of a specific distance index, from 0 to MaxInd (52). For brevity, the list to hold all the current skeletal elements with distance index DI is denoted as List[DI] (0<=DI<=MaxInd).

The search starts with distance index 0 and continues in the order of increasing distance indexes. This is generally necessary, because an existing skeletal element will produce new skeletal elements having a distance index bigger than or equal to that of the existing skeletal element. Starting with distance index 0 and marching in ascending order, for each List[DI], judge if List[DI] is empty (54). If List[DI] is not empty, remove the skeletal element p from the head of List[DI] (55). For each 26 neighbor q of voxel p, qεNₚ, if q is not a current skeletal element and its distance index is not less than that of p, then q is a skeletal element candidate. Also check if q is a skeletal voxel candidate (56).

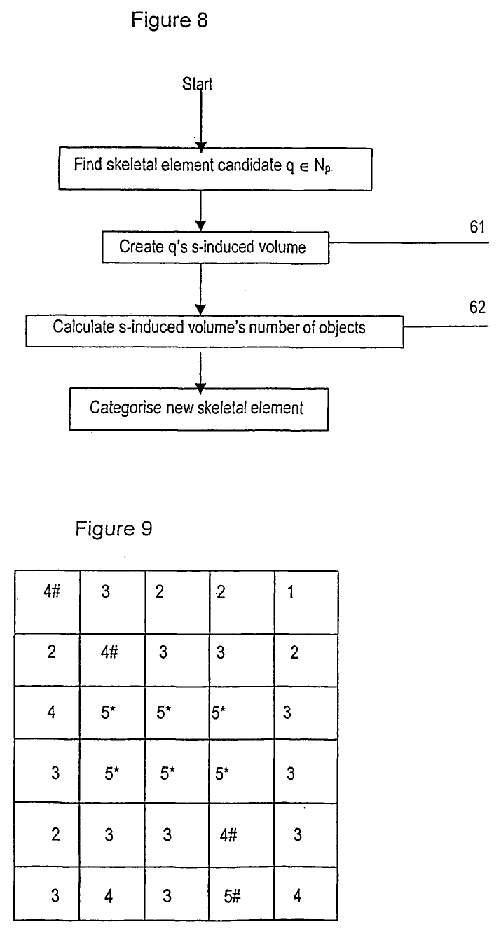

Now referring to FIG. 8, for each of the candidate skeletal voxel q, q ε Nₚ, q's s-induced binary volume is created (61). The number of objects of a s-induced volume is also calculated (62).

Now referring back to FIG. 7, the number of objects of the s-induced volume is used to judge if a skeletal element candidate is a new skeletal element (57).

When the number of objects of its s-induced volume is at least 2, the skeletal element candidate q, qεNₚ, is a newly produced skeletal element from the existing skeletal element p. If q is a newly produced skeletal element, then q is added to the corresponding list (58) and specifically added to List[Id[q]]. Then it is determined if List[DI] is empty (54).

Alternatively, if the skeletal element candidate is not a newly produced skeletal element, then the process is simply returned to step (54) to determine if List[DI] is empty.

The search from List[DI] for new skeletal elements continues until List[DI] is empty.

The added skeletal elements from the search of List[DI] will have a distance index not less than DI, which ensures that once List[DI-t] (t is non-negative integer, t<DI) is empty, it will be kept empty. When List[DI] is empty, DI is incremented by 1, and then the new DI is compared to the maximum distance index MaxInd as shown in step 55. If DI is greater than MaxInd, the search for skeletal elements is over, thus the final primary skeleton has been obtained. Otherwise, it is checked whether List[DI] is empty to search for new skeletal elements from List[DI] as indicated by step (54).

From this description, it is apparent that the search from an existing list of skeletal elements for new skeletal elements is a kind of propagation. Only the 26 neighbors of an existing skeletal element are checked which is a great advantage to gain speed.

Remove Redundant Local Maximum Voxels

In three-dimension space, the set of local maximum voxels could form some surface patches if the type of object voxels is not limited. In order to achieve a three-dimensional curve-like skeleton, the object voxels in the present invention are limited to be of a tree-like structure.

Likewise, the propagation of skeletal elements could result in both surfaces and curves. Even though it is supposed that the object voxels of the 3D binary image is of vessel trees, the local maximum voxels still can be quite dense in the sense that some of the local maximum voxels can form surface patches due to either incorrect segmentation or pathological status of vessels as shown in FIG. 9. In this regard FIG. 9 illustrates a two-dimensional array where the local maximum voxels with a distance index of 5 form a surface patch. All the local maximum voxels are marked with *. The rest of the skeletal elements are marked with #.

To gain a one-voxel wide skeletal curve, some local maximum voxels forming the surface patch need to be removed. A surface patch in this specification is defined as a set of local maximum voxels with the same distance index, satisfying the following two conditions:

1. Within the set of voxels, there is at least one voxel p, whose 26-neighbors Nₚwill contain at least other two non-maximum voxels;

2. For any voxel in the set, a 26-connected path to any other voxels in the set can be found.

A neighboring voxel of a surface patch is a skeletal element satisfying the following two conditions:

1. It is not a local maximum voxel;

2. Among its 26-neighbors, there is at least one neighbor being a local maximum voxel of the surface patch.

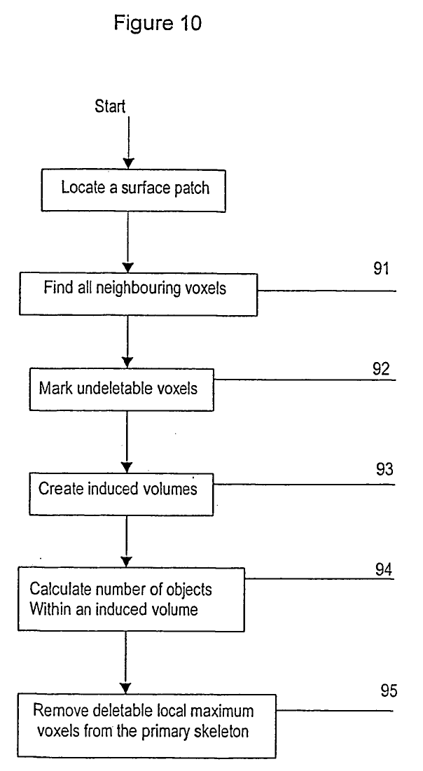

Now referring to FIG. 10 a flow chart illustrating the removal of redundant local maximum voxels is shown. Firstly, for any surface patch, the neighboring voxels are found (91). For each of the neighboring voxels of the surface patch, a local maximum voxel is marked as undeletable (92). If there is just one neighbor that is the local maximum voxel in the surface path, then this local maximum voxel is marked as undeletable. If there are at least two neighbors that are local maximum voxels in the surface patch, the following tiebreak rule is applied to mark one undeletable local maximum voxel:

1. If there is only one 6-connected neighbor that is the local maximum voxel of the surface match, then this local maximum voxel is marked undeletable;

2. If there are at least two 6-connected neighbors that are the local maximum voxels of the surface patch, the 6-connected neighbors are checked in descending priority: front, back, left, right, top, and down. The first met local maximum voxel is marked undeletable;

3. If there are no 6-connected neighbors, but there is at least one 18-connected voxel that belongs to the surface patch, choose one randomly and mark it as undeletable;

4. If there are no 18-connected neighbors, but there is at least one 26-connected voxel which belongs to the surface patch, choose one randomly and mark it as undeletable.

For each voxel p within the surface patch that has not been marked undeletable, its induced volume V_{ind3}^{(p)} (x, y, z) is formed (93) in the following way:

1. V_{ind3}^{(p)} (x, y, z) (0<=x<3, 0<=y<3, 0<=z<3) is initialized to 0;

2. For a neighboring voxel q, qεNₚ, if q is a skeletal element but not belongs to the surface patch, or q is marked undeletable, the corresponding element in V_{ind3}^{(p)} (x, y, z),

i.e., Vᵢₙ₃^{(p)}(q(x)−p (x)+1, q(y)−p(y)+1, q(z)−p(z)+1) is be set to 1.

Then the number of objects in the induced volume is calculated (94). If the number of objects is at least 2, then the local maximum voxel belonging to the surface patch is marked undeletable, otherwise it is marked deletable and is deleted from the primary skeleton (95). All the deletable local maximum voxels are also called redundant local maximum voxels in this invention.

Steps (91) to (95) are repeated until all the surface patches are processed, and a one-voxel wide three-dimensional skeleton of the vessel tree is achieved.

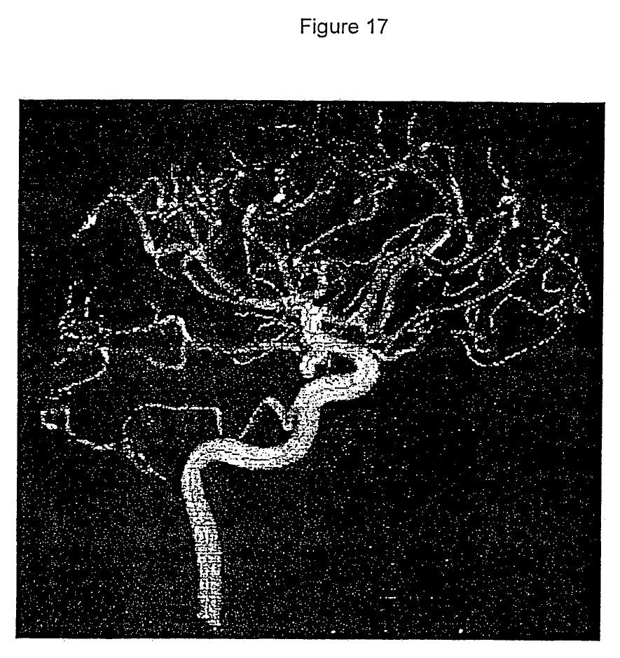

A working illustration of this embodiment of the invention is provided in FIGS. 16 and 17. FIG. 16 illustrates a snapshot of a human vessel tree. FIG. 17 illustrates a skeleton of the FIG. 16 vessel tree, which was calculated using the present embodiment of the invention. This skeleton tree is overlaid on the actual human vessel tree. In this regard, the accuracy and cleanness of the resulting skeleton is apparent.

Two Dimensional Skeletonization

A second embodiment of the present invention will now be described in relation to producing a skeleton of a two dimensional binary image.

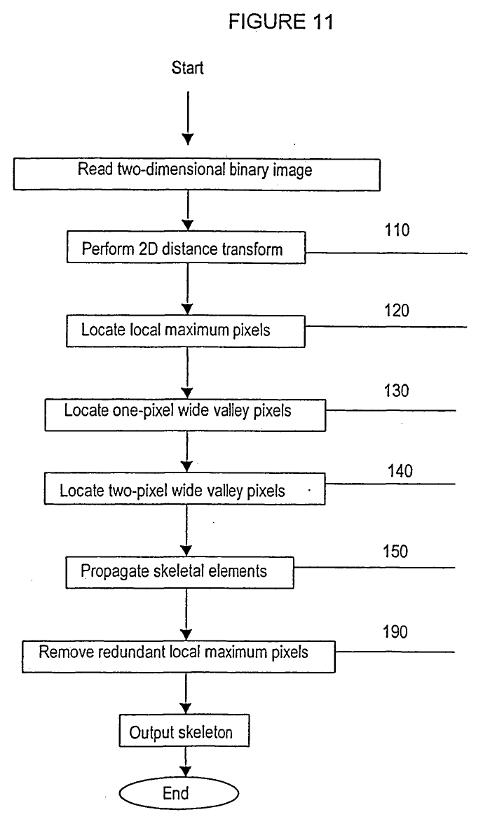

With reference to FIG. 11, a method according to this embodiment of the invention includes the following major steps:

1. performing 2D distance transform (110);

2. locating local maximum pixels (120);

3. locating one-pixel wide valley pixels (130);

4. locating two-pixel wide valley pixels (140);

5. propagating skeletal elements (150);

6. removing redundant local maximum pixels (190);

These steps will now be described in more detail.

For the purposes of this discussion, a binary image is denoted as IM(x,y). A 4-boundary pixel is an object pixel that has at least one of its 4-connected neighbors being a background pixel. An 8-boundary pixel is an object pixel that has at least one of its 8-neighbors being a background pixel. An interior pixel is an object pixel with all its 8-connected neighbors being object pixels. A pixel p's 8 neighbors are also denoted as Nₚ.

Performing Two-Dimensional Distance Transform

The three-dimensional distance transform discussed in relation to the first embodiment of the invention can be extended to two-dimensional image space. The modification is as following: the distance value of any object pixels with only 8-connected neighbor background pixels is defined as 0.717, and the distance value of any object pixels with only 4-connected neighbor background pixels is defined as 0. These two kinds of boundary pixels are denoted as 8-boundary pixels, and 4-boundary pixels respectively.

With the distance values 0, 0.717 for boundary pixels and the local Euclidean metric (1, 1.414) for iteration, a lookup table can be built for all the possible discrete distance values an object pixel could take, in an increasing order. This lookup table builds a unique correspondence between the two-dimensional distance transform value and its index. This index corresponding to the specific distance value is also called distance index hereafter.

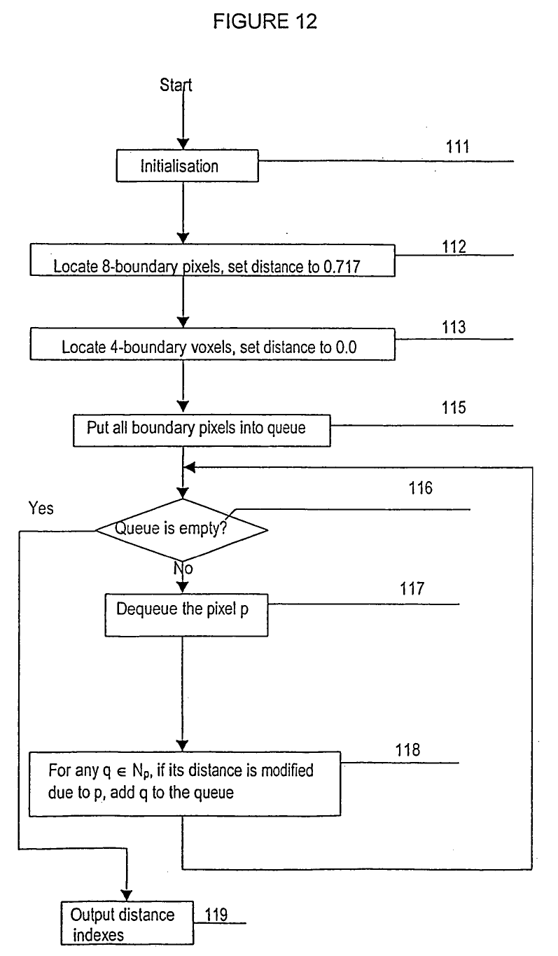

Now referring to FIG. 12, the two-dimensional distance transform according to this embodiment of the invention is illustrated.

The first step is initialization (111). This includes finding all the object pixels and setting their distance values to infinitive. In this example, the infinitive value is set to 5000. For all the background pixels, their distance values are set to any negative integer like −10.

Then the 8-boundary, and 4-boundary pixels are located and their distance values are set to 0.717, and 0 respectively (112, 113). All these boundary pixels coordinates together with their distance values are put into a queue (115). The queue is then checked (116).

If the queue is not empty, a pixel p with its distance value d(p) is dequeued (117) and its 8 neighbors Nₚchecked.

For any object pixel qεNₚ, suppose its current distance value is d(q). Then d(q) is compared with d(p)+δ(p), where δ(p) will take the value of 1, or 1.414 if q is an 8- or 4-connected neighbor of p respectively. If d(p)+δ(p) is smaller than d (q), then d(q) is set to be d(p)+δ(p), and q is put into the queue (118). Steps (117) to (118) continue until the queue is empty.

If the queue is empty, the calculated distance values of all the object pixels are checked against a lookup table similar to table 1 to get the distance indexes of all the object pixels (119). In the subsequent processing, it is the distance indexes rather than the distance values will be used.

Locating Local Maximum Pixels

A local maximum pixel is an object pixel whose distance is not smaller than that of any of its 8-connected neighbors. In the present invention the distance index is preferably used to locate such pixels. In this regard, the local maximum pixels are located by identifying the local maxima from the distance indexes of the two-dimensional distance transform. These local maxima are the local maximum pixels.

It also follows that a non-local maximum pixel is an object pixel that is not a local maximum pixel.

Locating One-Pixel Wide Valley Pixels

For any binary image B defined on a square lattice, a component is a set of pixels satisfying the following two conditions:

1. All the pixels in the component are object pixels;

2. For any pixel in the component, there is a path from this pixel to any other pixel of the component so that all the pixels on the path belong to the component.

The “number of objects” of a binary image B is defined as the number of components within B.

For any object pixel p in IM(x, y), its distance index is denoted as Id (p), its X coordinate is denoted as p(x), and Y coordinate p(y) respectively.

A 3×3 binary image related to pixel p, denoted as B_{ind3}^{(p)}(x, y) is formed in the following way:

1. B_{ind3}^{(p)}(1, 1)=0;

2. For any pixel q, qεNₚ, if its distance index Id (q) is bigger than that of p, then the corresponding element in B_{ind3}(x, y) is set to 1, else set to 0.

That is to say,

B_{ind3}^{(p)}(q(x)−p(x)+1, q(y)−p(y)+1)

will be set to 1 if Id (q)>Id (p), or 0 if Id (q)<=Id (p).

B_{ind3}^{(p)}(x, y) (0<=x<3, 0<=y<3) is called the induced image of pixel p.

A pixel p is called a one-pixel wide valley pixel if the number of objects of its induced image is at least 2.

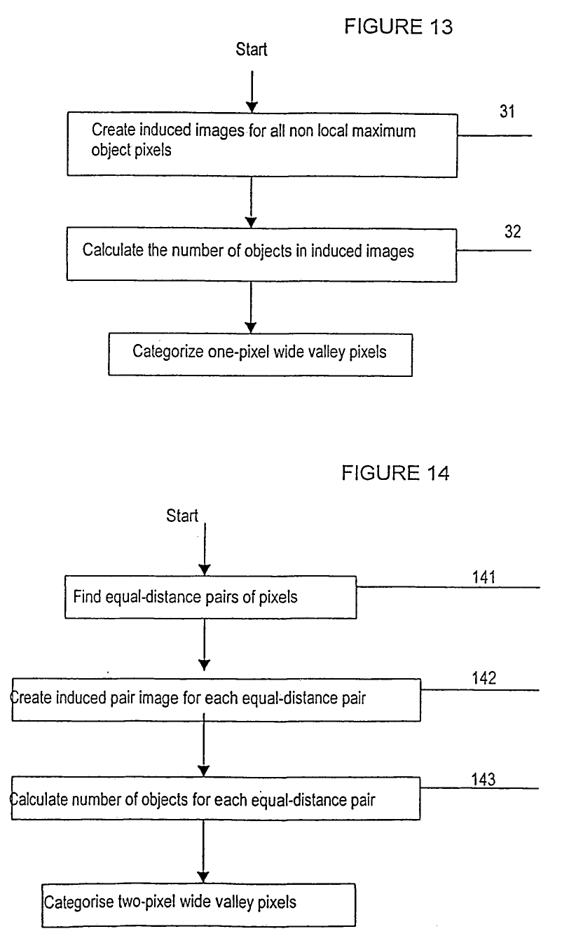

Now referring to FIG. 13 a flow chart for locating one-pixel wide valley pixels is illustrated. Firstly, for all the non-local maximum object pixels, their induced image is created (131). Then the number of objects for each induced image is calculated (132). If this number is at least 2, then the corresponding pixel is a one-pixel wide valley pixel.

The concept of one-pixel wide valley pixel in two-dimensional image space is the counterpart of the concept of one-voxel wide valley voxel in three-dimensional image space. This concept is unique to this embodiment of the invention.

Locating Two-Pixel Wide Valley Pixels

Two object pixels are called a pair of equal-distance pixels if they have the same distance index and are at least 8-neighbors.

Suppose that two object pixels p₁ and p₂ are a pair of equal-distance pixels with distance index Id (p₁). A 5×5 binary image related to p₁ and p₂, denoted as B_{ind5}^{(p1, p2)}(x, y), is formed in the following way:

1. B_{ind5}^{(p1, p2)}(x, y) is initialized to 0 for 0<=x<5, 0<=y<5;

2. For any object pixel q, qεNₚ₁ or qεNₚ₂, if its distance index Id (q) is bigger than Id (p₁), then the corresponding element in B_{ind5}^{(p1, p2)}(x, y) is set to 1.

That is to say,

B_{ind5}^{(p1, p2)}(q(x)−p₁(x)+2, q(y)−p₁(y)+2)

and

B_{ind5}^{(p1, p2)}(q(x)−p₂(x)+2, q(y)−p₂(y)+2)

will be set to 1 if Id (q)>Id (p₁).

B_{ind5}^{(p1, p2)}(x, y) (0<=x<5, 0<=y<5) is called the induced image of an equal-distance pair of pixels p₁ and p₂, and called the induced pair image for short thereafter.

Two object pixels are two-pixel wide valley pixels, if they satisfy the following conditions:

1. They are a pair of equal-distance pixels;

2. In their 8 neighbors, there is no one-pixel wide valley pixel;

3. In their 8 neighbors, there are no two-pixel wide valley pixels;

4. The number of objects of the induced pair image of the equal-distance pair is at least 2.

Now referring to FIG. 14 a flow chart for locating two-pixel wide valley pixels is illustrated. For all the non-local maximum object pixels, find all the possible equal-distance pairs of pixels (141). Create the induced pair images for all the equal-distance pairs that have no neighboring pixels being either one-pixel wide valley or two-pixel wide valley pixels (142). Calculate the number of objects for each induced pair image (143). If this number is at least 2, then the corresponding pixel pair is a two-pixel wide valley.

The concept of two-pixel wide valley pixels is also unique to this embodiment of the invention.

Propagating Skeletal Elements in Two-Dimensional Image Space

This procedure is based upon that described in the previous embodiment of the invention, being the propagation of skeletal elements in three-dimensional image space, may be used. This is particularly the case since the concepts of primary skeleton or the final primary skeleton, current primary skeleton are the same as defined in three-dimensional case.

In this regard, the method would be modified in terms of an object pixel being a skeletal element if it satisfies one of the following conditions:

1. It is a local maximum pixel;

2. It is a one-pixel wide pixel;

3. It is a part of a two-pixel wide valley pixels;

4. The number of objects in its s-induced image (see below for definition) is at least 2;

Further, the s-induced image of an object pixel p, denoted as Bₛ^{(p)}(x, y), is a 3×3 binary image formed by the following way:

1. Initialize Bₛ^{(p)}(x, y) to 0 for 0<=x<3, and 0<=y<3;

2. For any object pixel q, qεNₚ, if q's distance index is bigger than that of p, or q is already a skeletal element, then the corresponding element in Bₛ^{(p)}(x, y) is set to 1.

That is to say,

Bₛ^{(p)}(q(x)−p(x)+1, q(y)−p(y)+1)

will be set to 1 if

Id(q)>Id(p), or

pixel q is already a skeletal element.

Another difference is that in the present propagation procedure the number of objects of the s-induced image Bₛ^{(p)}(x, y) is checked for new skeletal elements.

Removing Redundant Local Maximum Pixels

This procedure is based upon the removal of redundant local maximum voxels described in the previous embodiment of the invention. The surface patch here, however, is the neighboring local maximum pixels.

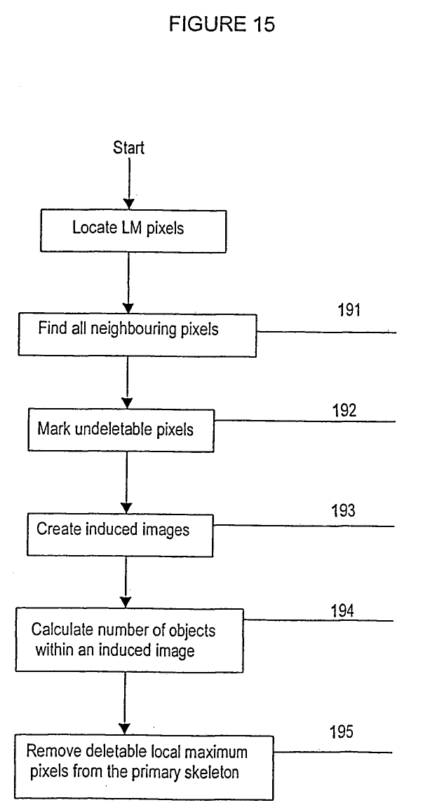

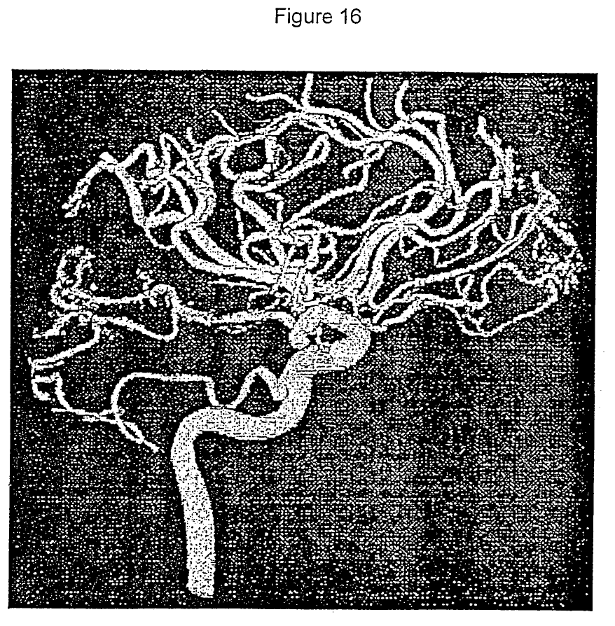

Referring to FIG. 15, for any surface patch, find the neighboring pixels (191). For each of the neighboring pixels of the surface patch, mark a local maximum pixel as undeletable (192).

For the neighboring pixels, if there is just one neighbor that is the local maximum pixel in the surface path, then this local maximum pixel is marked as undeletable. If there are at least two neighbors that are local maximum pixels in the surface patch, the following tiebreak rule is applied to mark one undeletable local maximum pixel:

1. If there is only one 4-connected neighbor that is the local maximum pixel of the surface match, then this local maximum pixel is marked undeletable;

2. If there are at least two 4-connected neighbors that are the local maximum pixels of the surface patch, check the 4-connected neighbors in descending priority: left, right, top, and down. The first met local maximum pixel is marked undeletable;

3. If there are no 4-connected neighbors, but there is at least one 8-connected pixel that belongs to the surface patch, choose one randomly and mark it as undeletable;

For each pixel p within the surface patch that has not been marked undeletable, its induced image B_{ind3}^{(p)}(x, y) is formed in the following way (193):

1. B_{ind3}^{(p)}(x, y) (0<=x<3, 0<=y<3) is initialized to 0;

2. For a neighboring pixel q, qεNₚ, if q is a skeletal element but not belongs to the surface patch, or q is marked undeletable, the corresponding element in B_{ind3}^{(p)}(x, y), i.e.,

B_{ind3}^{(p)}(q(x)−p(x)+1, q(y)−p(y)+1)

is be set to 1.

Then the number of objects in the induced image is calculated (194). If the number of objects is at least 2, then the local maximum pixel belonging to the surface patch is marked undeletable, otherwise it is marked deletable and is removed from the primary skeleton (195). Steps (191) to (195) are repeated until all the surface patches are processed so that a one-pixel wide two-dimensional skeleton is achieved.

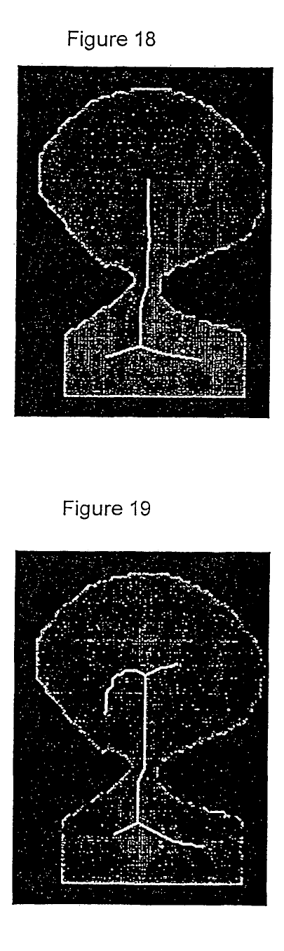

In this regard, referring to FIG. 18, a skeleton calculated using the present embodiment of the invention is illustrated, which is overlaid on the two dimensional binary image from which it was extracted.

As a comparison on the effectiveness of this embodiment of the invention, as compared to prior art methods, referring to FIG. 19, a skeleton calculated using a prior art method (Hilditch's method) is illustrated. Most of the existing 2D skeletonization methods produce a skeleton very similar to that produced by Hilditch's method, which is described in a publication entitled “Linear skeletons from square cupboards,” Machine Intelligence, vol. 4, pp. 402-420, 1969 by C. J. Hilditch. Hence Hilditch's method is taken as the basis for comparison.

Variations and additions are possible within the general inventive concept as will be apparent to those skilled in the art.

It will be appreciated that the broad inventive concept of the present invention may be applied to various types of three dimensional and two dimensional imaging applications and that the exact embodiments shown is intended to be merely illustrative and not limitative.

The claims defining the invention are as follows:

1. Method of skeletonizing a three dimensional binary volume image including the steps of:
(a) locating any local maximum voxels in the volume image;
(b) locating any one-voxel wide valley voxels in the volume image;
(c) locating any two-voxel wide valley voxels in the volume image; and
(d) forming a current primary skeleton, wherein the initial skeletal elements comprise all the located local maximum voxels, one-voxel wide valley voxels and two-voxel wide valley voxels.

2. Method of claim 1 further including the step of performing a three dimensional distance transform on the volume image, the transform including the steps of:
(a) locating boundary voxels and assigning a distance value of 0.866 to all 26-boundary voxels, 0.717 to all 18-boundary voxels and 0 to all 6-boundary voxels;
(b) queuing all boundary voxels;
(c) iteratively calculating distance values of the interior object voxels by comparing each queued voxel p having distance value d(p) with its neighbors q having distance values d(q), such that:
(i) if d(p)+δ(p) is less than d(q), then d(q) is set to d (p)+δ(p) and q is put into the queue;
(ii) otherwise, d(q) remains as the distance value of voxel q;
Wherein δ(p) takes the value of 1, 1.414 or 1.732 if q is a 26-, 18- or 6-connected neighbor of p respectively; and
(d) comparing the calculated distance values with a table of discrete distance values to obtain a distance index for each object voxel.

3. Method of claim 2 wherein the local maximum voxels are located by identifying local maxima of the distance indexes, whereby the local maxima are the local maximum voxels.

4. Method of claim 1 wherein any one-voxel wide valley voxels are located using the following steps:
(a) calculating an induced volume for each non-local maximum object voxel;
(b) calculating the number of objects for each induced volume, such that when the number of objects is at least two, the corresponding non-local maximum object voxel is a one-voxel wide valley voxel.

5. Method of claim 1 wherein any two-voxel wide valley voxels are located using the following steps:
(a) locating equal distance pairs of voxels from the non-local maximum object voxels;
(b) calculating an induced pair volume for each equal distance pair of voxels that do not have any one voxel wide valley voxels or two voxel wide valley voxels as neighbors;
(c) calculating the number of objects for each induced pair volume, such that when the number of objects is at least two, the corresponding equal distance voxel pair is a two-voxel wide valley voxel.

6. Method of claim 1 further including the process of forming a primary skeleton by determining any new skeletal elements from the initial skeletal elements, including the steps of:
(a) determining a maximum of the distance indexes of the initial skeletal elements of the current primary skeleton, MaxInd;
(b) organizing the current primary skeleton into MaxInd lists, each list containing the skeletal elements of the current primary skeleton having a specific distance index;
(c) in consecutive list order, comparing each skeletal element p with its neighbors q, such that:
(i) if q is not a current skeletal element and its distance index is not less than that of p, then q is a skeletal element candidate;
(ii) if q is a skeletal element candidate and also a new skeletal element, then q is added to the end of the corresponding list.

7. Method of claim 6 wherein the step of determining if q is a new skeletal element includes:
(a) calculating an s-induced volume for q;
(b) calculating the number of objects of the s-induced volume; and
(c) when the number of objects of the s-induced volume is at least two, then q is a new skeletal element.

8. Method as claimed in claim 1 further including the step of removing redundant local maximum voxels to obtain a one-voxel wide skeletal curve, including:
(a) locating any surface patches; and for each surface patch:
(i) determining the neighboring voxels;
(ii) if only one neighboring voxel is a local maximum voxel, designating that voxel as undeletable;
(iii) if two or more neighboring voxel are local maximum voxels, then:
(A) if there is only one 6-connected neighbor that is the local maximum voxel, then this voxel is marked undeletable; or
(B) if there are at least two 6-connected neighbors that are local maximums, then the first met local maximum in a front, back, left, right, top and down comparison, is marked undeletable; or
(C) if there are no 6-connected neighbors, but at least one 18-connected voxel, one of the at least one 18-connected voxels is marked undeletable; or
(D) if there are no 18-connected neighbors, but at least one 26-connected voxel, one of the at least one 26-connected voxels is marked undeletable;
(iv) calculating the induced volume of all voxels within the surface patch that have not been marked undeletable;
(v) calculating the number of objects within each induced volume;
(vi) if the number of objects is at least 2, then the local maximum voxel of the surface patch is marked undeletable, otherwise it is deleted.

9. Method of claim 1 wherein the volume image is a three-dimensional binary volume including one or more vessel trees.

10. Method of claim 9 wherein the vessel trees are any kinds of vessel trees including human vessel trees and any other animal vessel trees.

11. In a method of skeletonizing a three dimensional volume image, a method of locating one-voxel wide valley voxels including the following steps:
(a) calculating an induced volume for each non-local maximum object voxel;
(b) calculating the number of objects for each induced volume, such that when the number of objects is at least two, the corresponding non-local maximum object voxel is a one-voxel wide valley voxel.

12. In a method of skeletonizing a three-dimensional volume image, a method of locating two-voxel wide valley voxels including the following steps:
(a) locating equal distance pairs of voxels from the non-local maximum object voxels;
(b) calculating an induced pair volume for each equal distance pair of voxels that do not have any one voxel wide valley voxels or two voxel wide valley voxels as neighbors;
(c) calculating the number of objects for each induced pair volume, such that when the number of objects is at least two, the corresponding equal distance voxel pair is a two-voxel wide valley voxel.

13. Computer program product including a computer usable medium having computer readable program code and computer readable system code embodied on said medium for skeletonizing a three dimensional volume image within a data processing system, said computer program product further including computer readable code within said computer usable medium for:
(a) locating any local maximum voxels in the volume image;
(b) locating any one-voxel wide valley voxels in the volume image;
(c) locating any two-voxel wide valley voxels in the volume image; and
(d) forming a current primary skeleton, wherein the initial skeletal elements comprise the located local maximum voxels, one-voxel wide valley voxels and two-voxel wide valley voxels.

14. Method of skeletonizing a two dimensional binary image including the steps of:
(a) locating any local maximum pixels in the binary image;
(b) locating any one-pixel wide valley pixels in the binary image;
(c) locating any two-pixel wide valley pixels in the binary image; and
(d) forming a current primary skeleton, wherein the initial skeletal elements comprise the local maximum pixels, one-pixel wide valley pixels and two-pixel wide valley pixels.

15. Method of claim 14 further including the step of performing a two dimensional distance transform on the binary image, the transform including the steps of:
(a) locating boundary pixels and assigning a distance value of 0.717 to all 8-boundary pixels and 0 to all 4-boundary pixels;
(b) queuing all boundary pixels;
(c) iteratively calculating distance values of the interior object pixels by comparing each queued pixel p having distance value d(p) with its neighbors q having distance values d(q), such that:
(i) if d(p)+δ(p) is less than d(q), then d(q) is set to d(p)+δ(p) and q is put into the queue;
(ii) otherwise, d(q) remains as the distance value of pixel q;
Wherein δ(p) takes the value of 1 or 1.414 if q is an 8- or 4-connected neighbor of p respectively; and
(d) comparing the calculated distance values with a table of discrete distance values to obtain a distance index for each object pixel.

16. Method of claim 15 wherein the local maximum pixels are located by identifying local maxima of the distance indexes, whereby the local maxima are the local maximum pixels.

17. Method of claim 14 wherein any one-pixel wide valley pixels are located using the following steps:
(a) calculating an induced image for each non-local maximum object pixels;
(b) calculating the number of objects for each induced image, such that when the number of objects is at least two, the corresponding non-local maximum object pixel is a one-pixel wide valley pixel.

18. Method of claim 14 wherein any two-pixel wide valley pixels are located using the following steps:
(a) locating equal distance pairs of pixels from the non-local maximum object pixels;
(b) calculating an induced pair image for each equal distance pair of pixels that do not have any one pixel wide valley pixels or two pixel wide valley pixels as neighbors;
(c) calculating the number of objects for each induced pair image, such that when the number of objects is at least two, the corresponding equal distance pixel pair is a two-pixel wide valley pixel.

19. Method of claim 14 further including the process of forming a primary skeleton by determining any new skeletal elements from the initial skeletal elements, including the steps of:
(a) determining a maximum of the distance indexes of the initial skeletal elements of the current primary skeleton, MaxInd;
(b) organizing the current primary skeleton into MaxInd lists, each list containing the skeletal elements of the current primary skeleton having a specific distance index;
(c) in consecutive list order, comparing each skeletal element p with its neighbors q, such that:
(i) if q is not a current skeletal element and its distance index is not less than that of p, then q is a skeletal element candidate;
(ii) if q is a skeletal element candidate and also a new skeletal element, then q is added to the end of the corresponding list.

20. Method of claim 19 wherein the step of determining if q is a new skeletal element includes:
(a) calculating an s-induced image for q;
(b) calculating the number of objects of the s-induced image; and
(c) when the number of objects of the s-induced image is at least two, then q is a new skeletal element.

21. Method as claimed in claim 14 further including the step of removing redundant local maximum pixels to obtain a one-pixel wide skeletal curve, including:
(a) locating any surface patches; and for each surface patch:
(i) determining the neighboring pixels;
(ii) if only one neighboring pixel is a local maximum pixel, designating that pixel as undeletable;
(iii) if two or more neighboring pixel are local maximum pixels, then:
(A) if there is only one 4-connected neighbor that is the local maximum pixel, then this pixel is marked undeletable; or
(B) if there are at least two 4-connected neighbors that are local maximums, then the first met local maximum in a left, right, top and down comparison, is marked undeletable; or
(C) if there are no 4-connected neighbors, but at least one 8-connected pixel, one of the at least one 8-connected pixels is marked undeletable; or
(iv) calculating the induced image of all pixels within the surface patch that have not been marked undeletable;
(v) calculating the number of objects within each induced image;
(vi) if the number of objects is at least 2, then the local maximum pixel of the surface patch is marked undeletable, otherwise it is deleted.

22. In a method of skeletonizing a two dimensional binary image, a method of locating one-pixel wide valley pixels including the following steps:
(a) calculating an induced image for each non-local maximum object pixel;
(b) calculating the number of objects for each induced image, such that when the number of objects is at least two, the corresponding non-local maximum object pixel is a one-pixel wide valley pixel.

23. In a method of skeletonizing a two-dimensional binary image, a method of locating two-pixel wide valley pixels including the following steps:
(a) locating equal distance pairs of pixels from the non-local maximum object pixels;
(b) calculating an induced pair image for each equal distance pair of pixels that do not have any one pixel wide valley pixels or two pixel wide valley pixels as neighbors;
(c) calculating the number of objects for each induced pair image, such that when the number of objects is at least two, the corresponding equal distance pixel pair is a two-pixel wide valley pixel.

24. Computer program product including a computer usable medium having computer readable program code and computer readable system code embodied on said medium for skeletonizing a two dimensional binary image within a data processing system, said computer program product further including computer readable code within said computer usable medium for:
(a) locating any local maximum pixels in the binary image;
(b) locating any one-pixel wide valley pixels in the binary image;
(c) locating any two-pixel wide valley pixels in the binary image; and
(d) forming a current primary skeleton, wherein the initial skeletal elements comprise the located local maximum pixels, one-pixel wide valley pixels and two-pixel wide valley pixels.
